(19) United States
(12) Patent Application Publication
(10) Pub. No.: US 2026/0214445 A1
(43) Pub. Date: Jul. 23, 2026

(54) SYSTEMS AND METHODS FOR SECURE LOWER LAYER SIGNALING IN A WIRELESS NETWORK

(71) Applicant: Verizon Patent and Licensing Inc., Basking Ridge, NJ (US)

(72) Inventors: Yousif Targali, Sammamish, WA (US); Vishwanath Ramamurthi, San Ramon, CA (US)

(73) Assignee: Verizon Patent and Licensing Inc., Basking Ridge, NJ (US)

(21) Appl. No.: 19/033,639

(22) Filed: Jan. 22, 2025

(51) Int. Cl. H04W 12/043; H04W 12/041; H04W 36/08; H04W 76/20

(52) U.S. Cl. CPC H04W 12/043; H04W 12/041; H04W 36/08; H04W 76/20

(57) ABSTRACT

A device described herein may generate or receive a first key; utilize the first key to secure a first set of communications between the device and a User Equipment (“UE”); and identify that the first key has been provided to a second device. The device may further, based on identifying that the first key has been provided to a second device, generate a second key based on the first key, and instruct the UE to generate the second key based on the first key. The device may utilize the second key to secure a second set of communications between the first device and the UE. The device may include a base station of a wireless network.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Security techniques such as encryption may be used in a wireless network in order to verify authenticity of messages or commands sent by the wireless network to a UE, to prevent messages or commands from being accessed by unauthorized entities, and/or to otherwise provide security to the wireless network.

### BRIEF DESCRIPTION OF THE DRAWINGS

FIG. 1 illustrates an example of securing communications between a base station and a UE in a wireless network;

FIG. 2 illustrates an example of an intra-Central Unit (“CU”) handover of a UE in a wireless network;

FIG. 3 illustrates an example of an inter-CU handover of a UE in a wireless network;

FIG. 4 illustrates an example of securing lower layer signaling between a base station and a UE in a wireless network;

FIGS. 5A and 5B illustrates examples of key derivation functions (“KDFs”) implemented or maintained by UEs and base stations of a wireless network;

FIG. 6 illustrates an example overview of some embodiments described herein;

FIG. 7 illustrates an example process for securing communications between a UE and a base station, such as in a handover scenario, in accordance with some embodiments;

FIGS. 8 and 9 illustrate example environments in which one or more embodiments, described herein, may be implemented;

FIG. 10 illustrates an example arrangement of a radio access network (“RAN”), in accordance with some embodiments;

FIG. 11 illustrates an example arrangement of an Open RAN (“O-RAN”) environment in which one or more embodiments, described herein, may be implemented; and

FIG. 12 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Wireless networks may utilize cryptographic security techniques, such as the use of key-based encryption and/or decryption, to maintain the security of the wireless networks. For example, wireless networks may utilize asymmetric key-based techniques, symmetric key-based techniques, or other suitable key-based techniques to encrypt and/or decrypt control plane signaling and/or user plane traffic. Embodiments described herein further provide security to lower layer signaling, such as Media Access Control (“MAC”) layer. In one example embodiment described below, lower layer communications such as a Lower-layer Trigger Mobility (“LTM”) command, may be secured using one or more key-based security techniques, thereby enhancing the security of a wireless network while maintaining the reduced latency and traffic overhead of LTM signaling.

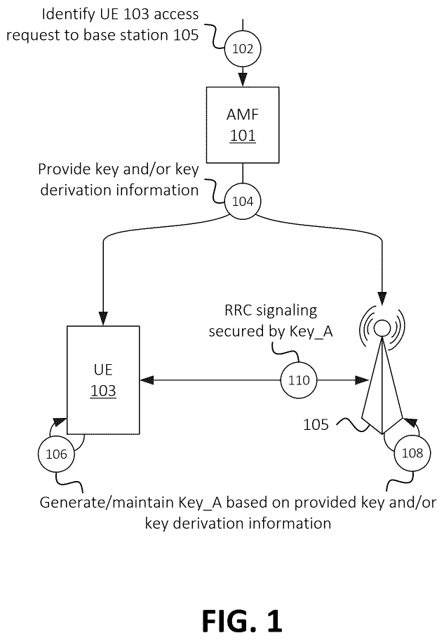

As shown in FIG. 1, UEs and elements of a RAN of a wireless network, such as base stations, may maintain one or more keys that are used to secure (e.g., encrypt and/or decrypt) certain communications between the UEs and the elements of the RAN, such as Radio Resource Control (“RRC”)-based communications. For example, a mobility element of the wireless network, such as Access and Mobility Management Function (“AMF”) 101, may identify (at 102) an access request associated with a particular UE 103 and a particular base station 105 of the RAN. AMF 101 may, for example, receive a request from UE 103 via Non-Access Stratum (“NAS”) signaling, from base station 105, and/or from some other suitable source.

AMF 101 may provide (at 104) one or more keys and/or key derivation information to UE 103 and base station 105. In one example implementation, AMF 101 may maintain a public or shared key (sometimes referred to as “K_{AMF}”), and may provide (at 104) such key to UE 103 and base station 105 (e.g., based on identifying that UE 103 is associated with a request to access or connect to base station 105). In some embodiments, AMF 101 may additionally, or alternatively, provide key derivation information, which UE 103 and base station 105 may subsequently utilize to generate a different key, referred to herein as “Key_A.” In some implementations, this different key, generated based on the key or key derivation information from AMF 101, may be referred to as K_{GNB}. As discussed below, UE 103 and base station 105 may both include or implement one or more KDFs, based on which UE 103 and base station 105 may both generate or derive Key_A from the key and/or key derivation information provided by AMF 101. In some embodiments, UE 103 may receive the key, derivation information, and/or one or more KDFs from another source (e.g., other than AMF 101), such as during a configuration and/or initialization procedure.

For example, as shown, UE 103 may generate and/or maintain (at 106) Key_A based on the provided key and/or key derivation information, and base station 105 may also generate and/or maintain (at 108) the same Key_A based on the provided key and/or key derivation information. In this manner, UE 103 and base station 105 both have possession of Key_A, without Key_A itself having been transmitted or communicated via any external communication link.

Additionally, as discussed below, base station 105 may be implemented using a CU/Distributed Unit (“DU”) split architecture, in which a particular CU may be communicatively coupled to multiple DUs. In such implementations, maintaining (at 108) Key_A may include Key_A being maintained by a particular CU, which may use Key_A to encrypt and/or decrypt communications sent or received via one or more DUs. For example, DUs may handle or process lower level communications such as Radio Link Control (“RLC”) layer communications, Media Access Control (“MAC”) layer communications, and/or physical (“PHY”) layer communications, or the like, while CUs may handle or process communications at other layers such as the Packet Data Convergence Protocol (“PDCP”) layer or the Radio Resource Control (“RRC”) layer. Key_A may, in some embodiments, be associated with the PDCP layer (e.g., used for PDCP layer encryption and/or decryption), the RRC layer, and/or some other layer of traffic handled or processed by CUs. In this manner, Key_A may be used by base station 105 in a CU/DU split architecture, in which a CU uses Key_A to encrypt and/or decrypt communications sent or received one or more associated DUs.

Key_A may accordingly be used to secure (at 110) signaling between UE 103 and base station 105, such as RRC signaling. As one example, Key_A may be a symmetric key used by UE 103 and/or base station 105 to encrypt and/or decrypt RRC signaling, such as connection requests, connection modification requests, handover requests, handover commands, UE-generated measurement reports, or the like.

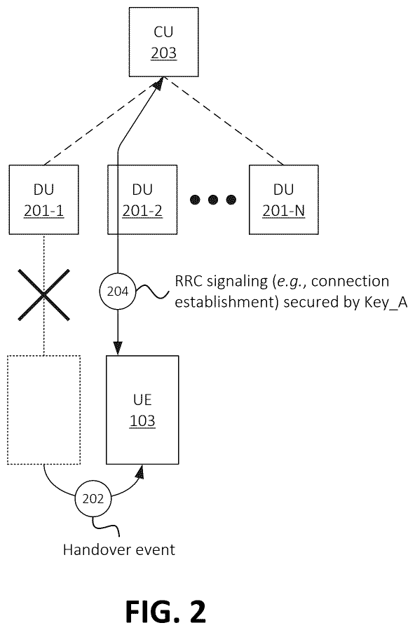

For example, as shown in FIG. 2, assume that a handover event occurs (at 202), in which UE 103 is handed over from DU 201-1 to DU 201-2, which are both associated with (e.g., communicatively coupled to, controlled by, etc. the same particular CU 203). That is, in this example, assume that UE 103 is first connected to DU 201-1, and subsequently connects (or is instructed to connect) to DU 201-2. In this example, since DUs 201-1 and 201-2 are both associated with the same CU 203, Key_A (e.g., which is also maintained by UE 103, as discussed above) may be used (at 204) to secure (e.g., encrypt and/or decrypt) control plane signaling used by UE 103 and CU 203 (e.g., as sent or received via DU 201-2) to facilitate the handover to DU 201-2. As discussed above, such control plane signaling may include RRC signaling.

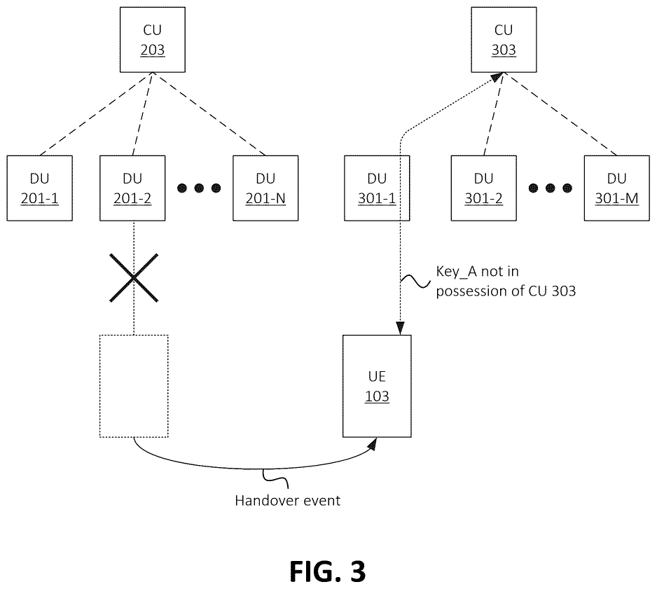

On the other hand, situations may arise in which UE 103 is handed over in an inter-CU handover scenario, an inter-base station handover scenario, or the like. For example, as shown in FIG. 3, assume that a handover event occurs in which UE 103 is handed over from DU 201-2, associated with a first CU 203, to DU 301-1 which is associated with a second CU 303 (e.g., which may also be communicatively coupled to one or more other DUs, such as DU 301-2, 301-M, and so on).

In some implementations, CU 303 may not be in possession of Key_A. For example, in some embodiments, CU 303 may not implement or may not be associated with the same KDF(s) as UE 103 and CU 203, and/or may otherwise not have the capability to generate Key_A based on a key or key derivation information previously provided (e.g., at 102) to UE 103 and CU 203.

In such implementations, control plane signaling between CU 303 and UE 103 via DU 301-1, such as RRC signaling, may not be able to be secured without the generation of a new key to be used by CU 303 and UE 103. As noted above, providing Key_A to CU 303 (e.g., by UE 103 and/or by CU 203) may lead to a potential compromise of Key_A, inasmuch as if a communication link between CU 203 and CU 303 is compromised, Key_A may be accessible by a malicious entity and may thusly be compromised.

As discussed herein, embodiments provide for the generation of a second key to be used between UE 103 and its source base station (e.g., CU 203 and/or base station 105 with which CU 203 is associated), while the first key (e.g., Key_A) is provided to a device or system external to base station 105 and/or CU 203 (such as CU 303, in this example). In this manner, communications between UE 103 and its source CU 203 may continue to be secure even in scenarios where Key_A becomes compromised in the providing of Key_A to CU 303.

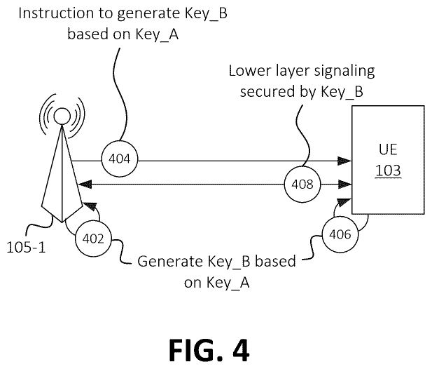

For example, as shown in FIG. 4, UE 103 may be connected to a particular base station 105-1. Base station 105-1 may generate (at 402) the second key (referred to herein as “Key_B”). Base station 105-1 may, for example, use one or more KDFs to generate Key_B (e.g., the second key). In some embodiments, generating Key_B may be based on the first key (e.g., Key_A). For example, a particular KDF used to generate Key_B may utilize Key_A (and/or a portion of Key_A, a value derived from or computed based on Key_A, etc.) as an input.

Base station 105-1 may instruct (at 404) UE 103 to generate the second key, based on Key_A. The instruction (at 404) may include an identifier or index associated with Key_A, in order to indicate that UE 103 should use Key_A when generating Key_B (e.g., that Key_A should be provided as an input to one or more KDFs). In some embodiments, the instruction (at 404) may be provided via RRC signaling or some other suitable communication pathway.

UE 103 may accordingly generate (at 406) Key_B based on Key_A. In this manner, UE 103 and base station 105-1 may both have possession of Key_B, without Key_B itself having been communicated between base station 105-1 and UE 103. The second key (e.g., Key_B) may be used to secure (e.g., encrypt and/or decrypt) for communications between UE 103 and base station 105-1. For example, the second key may be used as a symmetric key to secure the communications between UE 103 and base station 105-1. In some embodiments, the communications (at 408) may include LTM commands, MAC layer communications, or other suitable types of communications.

In some embodiments, base station 105-1 may generate (at 402) Key_B, and/or instruct (at 404) UE 103 to generate Key_B based on identifying events such as a handover event, a connection event, a disconnection event, and/or some other suitable triggering event associated with UE 103 and/or one or more other base stations 105. In one embodiment, base station 105-1 may perform (at 402 and 404) such actions based on determining that UE 103 should or may be handed over to a different base station 105. In some embodiments, base station 105-1 may perform (at 402 and 404) such actions when determining that the different base station 105 implements a separate CU from a CU implemented by base station 105-1. On the other hand, in some embodiments, base station 105-1 may forgo performing (at 402 and 404) such actions when identifying an intra-CU handover event of UE 103 (e.g., a handover of UE 103 from one DU to another, where both DUs are communicatively coupled to the same CU). That is, in situations where the base station or DU to which UE 103 is being handed over already has possession of Key_A, it may not be necessary to generate or use Key_B in order to maintain security of the network, as there may be minimal or no risk of compromise of Key_A in these situations (e.g., inasmuch as Key_A does not need to be communicated in an inter-CU or inter-base station fashion).

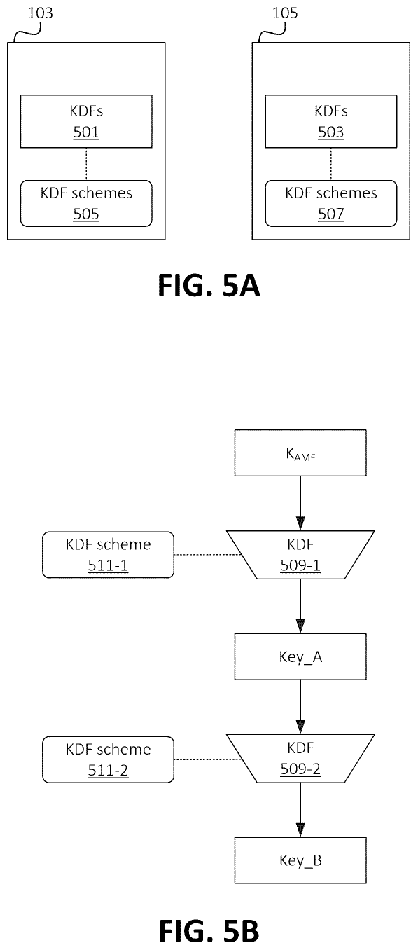

As noted above, and as shown in FIG. 5A, UEs 103 and base stations 105 may implement respective sets of KDFs in order to generate one or more keys used to secure various aspects of network communications associated with UEs 103 and/or base stations 105. For example, a particular UE 103 may implement a first set of KDFs 501, and a particular base station 105 may implement a second set of KDFs 503. UE 103 may further implement or maintain a first set of KDF schemes 505, and base station 105 may implement or maintain a second set of KDF schemes 507. A particular KDF scheme may include one or more algorithms, parameters, variables, etc. used by a particular KDF in order to generate one or more keys, key pairs, or other cryptographic information.

FIG. 5B illustrates particular KDFs 509 and KDF schemes 511 that may be implemented or maintained by UE 103 and by base station 105. For example, the first set of KDFs 501 may include KDFs 509 (e.g., KDFs 509-1 and 509-2), and the second set of KDFs 503 may also include the same KDFs 509 (e.g., KDFs 509-1 and 509-2). Similarly, the first set of KDF schemes 505 may include KDF schemes 511 (e.g., KDF schemes 511-1 and 511-2), and the second set of KDF schemes 507 may also include the same KDF schemes 511 (e.g., KDF schemes 511-1 and 511-2). In some embodiments, the first set of KDFs 501 may include one or more additional KDFs not included in the second set of KDFs 503, and/or the second set of KDFs 503 may include one or more additional KDFs not included in the first set of KDFs 501. Similarly, the first set of KDF schemes 505 may include one or more additional KDF schemes not included in the second set of KDF schemes 507, and/or the second set of KDF schemes 507 may include one or more additional KDF schemes not included in the first set of KDF schemes 505. That is, KDFs 509-1 and 509-2, and KDF schemes 511-1 and 511-2, may be a set of KDFs and KDF schemes that are common to both UE 103 and base station 105.

As shown, KDF 509-1 may be used to generate Key_A based on a first key (e.g., K_{AMF}) as well as a first KDF scheme 511-1. As noted above, KDF scheme 511-1 may include one or more algorithms, parameters, operations, etc. to perform with respect to K_{AMF} and/or other information in order to generate Key_A. Additionally, KDF 509-2 may be used to generate Key_B based on Key_A and further based on KDF scheme 511-2.

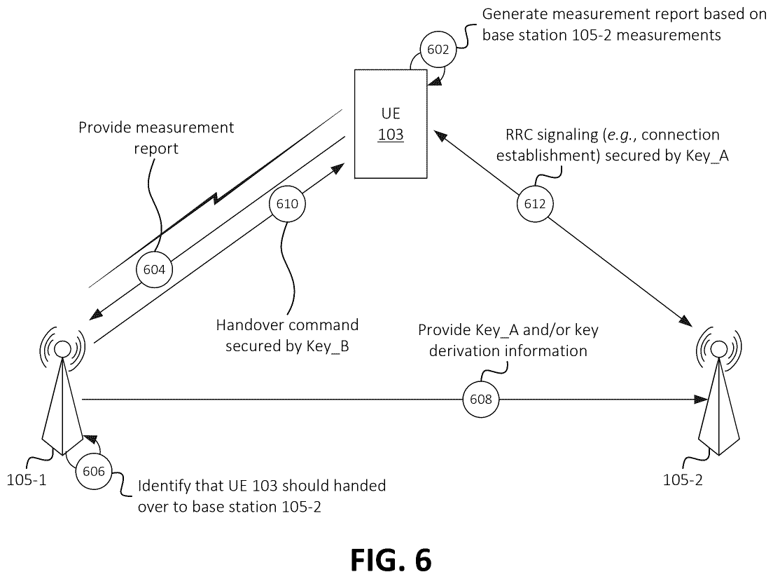

FIG. 6 illustrates an example scenario in which communications between UE 103 and base station 105-1, to which UE 103 is connected, are secured in accordance with some embodiments (e.g., using a second key generated using techniques described above). As shown, for example, UE 103 may be connected to base station 105-1 (e.g., base station 105-1 may be a “source” base station in the context of a handover involving UE 103). While UE 103 is connected to base station 105-1, UE 103 may detect wireless signals, such as system broadcasts or other wireless signals, from another base station 105-2 (e.g., a neighboring base station). UE 103 may measure or detect attributes of the wireless signals detected from base station 105-2, such as Signal-to-Interference-and-Noise-Ratio (“SINR”), Received Signal Strength Indicator (“RSSI”), Reference Signal Received Power (“RSRP”), Reference Signal Received Quality (“RSRQ”), Channel Quality Indicator (“CQI”), and/or other metrics or attributes. UE 103 may generate (at 602) a measurement report based on the detected attributes of the wireless signals. The measurement report may include one or more identifiers of base station 105-2, which may be included in or determined based on the detected wireless signals from base station 105-2. UE 103 may provide (at 604) the measurement report to base station 105-1.

Base station 105-1 may identify (at 606) that UE 103 should be handed over to base station 105-2 (e.g., may detect a handover event). In one example, base station 105-1 may identify that wireless signals received by UE 103 from base station 105-2 are associated with higher signal strength or quality than wireless signals between UE 103 and base station 105-1. In some embodiments, base station 105-1 may detect the handover event based on additional or different information, and/or based on some triggering event in addition to or in lieu of a measurement report received from UE 103. For example, a RAN controller may instruct base station 105-1 to initiate a handover of UE 103 from base station 105-1 to base station 105-2.

Based on the identification (at 606) that UE 103 should be handed over to base station 105-2, base station 105-1 may provide (at 608) Key_A and/or suitable key derivation information (e.g., K_{AMF} and/or other information based on which Key_A was generated) to base station 105-2, such that base station 105-2 is able to generate and/or maintain Key_A. Base station 105-1 may provide (at 608) such information via an X2 interface, an Xn interface, and/or some other suitable communication pathway between base stations 105-1 and 105-2. As noted above, the exposure of Key_A in this manner may potentially introduce security risks, inasmuch as a compromise of the communication pathway between base stations 105-1 and 105-2 may result in a compromise of Key_A.

Base station 105-1 may further provide (at 610) a handover command to UE 103, where such command is secured by Key_B. For example, base station 105-1 may utilize Key_B as a symmetric key to encrypt the handover command to UE 103, and UE 103 may utilize Key_B as a symmetric key to decrypt the handover command. In some embodiments, the handover command may be provided as LTM signaling (e.g., at the MAC layer), which may potentially exhibit lower latency and reduced overhead as compared to higher layer signaling such as RRC signaling. In situations where Key_B has not been shared or sent via a communication link (e.g., transmitted from base station 105-1 and/or from UE 103), Key_B may be considered secure, or more secure than Key_A which is provided via a communication pathway between base stations 105-1 and 105-2. In this manner, UE 103 may be able to authenticate the handover command (at 610) as having been sent from a trusted source (e.g., base station 105-1) rather than from a potentially malicious source.

Further, UE 103 and base station 105-2 may utilize (at 612) Key_A in control signaling between UE 103 and base station 105-2, such as a connection establishment procedure between UE 103 and base station 105-2. For example, UE 103 and base station 105-2 may encrypt and/or decrypt RRC signaling using Key_A (e.g., as a symmetric key). In this manner, base station 105-2 and UE 103 do not need to establish a new key (e.g., which may involve receiving a new K_{AMF} from AMF 101 and generating or deriving a new key based on K_{AMF}), thus further reducing latency and processing overhead in the connection of UE 103 to base station 105-2.

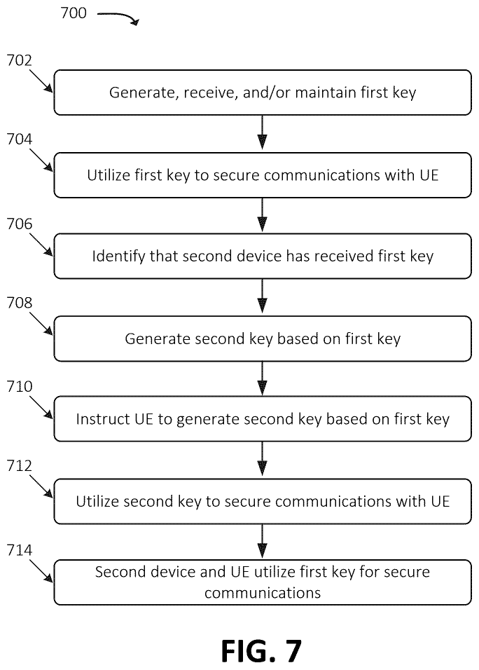

FIG. 7 illustrates an example process 700 for securing communications between a UE and a base station, such as in a handover scenario, in accordance with some embodiments. In some embodiments, some or all of process 700 may be performed by a particular base station 105 (e.g., a base station to which a particular UE 103 is connected). In some embodiments, one or more other devices may perform some or all of process 700 in concert with, and/or in lieu of, base station 105.

As shown, process 700 may include generating, receiving, and/or maintaining (at 702) a first key. For example, as discussed above, a particular base station 105-1 may receive (e.g., from AMF 101 or some other suitable source), the first key and/or key derivation information (e.g., a different key, such as K_{AMF}) based on which the first key may be generated. base station 105-1 may, for example, implement a particular KDF and/or a particular KDF scheme (e.g., KDF 509-1 and/or KDF scheme 511-1, in an example described above) in order to generate the first key. As noted above, a particular UE 103 may have also received or generated the first key (e.g., from AMF 101 and/or some other source).

Process 700 may further include utilizing (at 704) the first key to secure communications with UE 103. For example, base station 105-1 and UE 103 may communicate RRC control plane messages to each other, where such messages are encrypted or otherwise secured using the first key (e.g., as a symmetric key).

Process 700 may additionally include identifying (at 706) that a second device has received the first key. For example, base station 105-1 may identify that a second device, such as a second base station 105-2, has received the first key. In some embodiments, base station 105-1 may have provided the first key, or suitable key derivation information based on which the first key may be generated, to base station 105-2 (e.g., based on identifying a handover event associated with UE 103 and base station 105-2).

Process 700 may also include generating (at 708) a second key based on the first key. For example, base station 105-1 may utilize another KDF and/or another KDF scheme (e.g., KDF 509-2 and/or KDF scheme 511-2) to generate the second key. In some embodiments, the first key may be used as an input to KDF 509-2.

Process 700 may further include instructing (at 710) UE 103 to generate a second key based on the first key. For example, base station 105-1 may indicate, to UE 103, that UE 103 should utilize KDF 509-2 and/or KDF scheme 511-2 to generate the second key. In some embodiments, base station 105-1 may indicate that the second key should be generated based on the first key.

Process 700 may additionally include utilizing (at 712) the second key to secure communications with UE 103. For example, base station 105-1 may utilize the second key to encrypt, decrypt, etc. communications with UE 103, such as LTM commands, MAC layer communications, or the like. In this manner, such communications may be secured by a key that was not provided external to UE 103 and/or to base station 105-1, and may retain low-latency and low-overhead properties of LTM commands, MAC layer communications, etc.

As discussed above, the second device and UE 103 may utilize (at 714) the first key for secure communications. For example, UE 103 and base station 105-2 may perform RRC signaling and/or other suitable messaging in a secure manner, such as using the first key to encrypt and/or decrypt such communications between UE 103 and base station 105-2. As discussed above, the use of the first key may eliminate the need for base station 105-2 to request or obtain the first key, or suitable key derivation, from AMF 101 or some other source, thus reducing the latency and processing overhead associated of a connection procedure of UE 103 to base station 105-2.

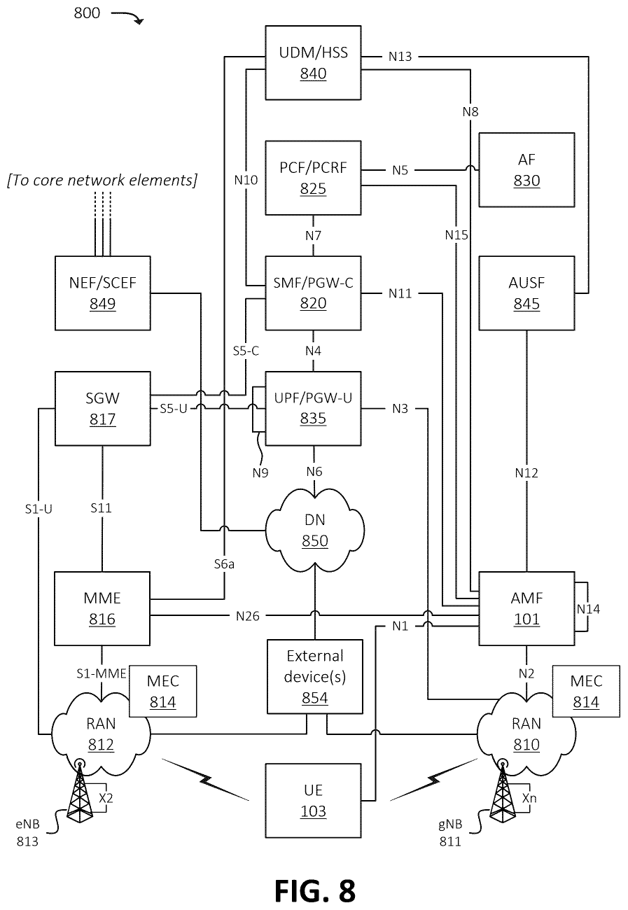

FIG. 8 illustrates an example environment 800, in which one or more embodiments may be implemented. In some embodiments, environment 800 may correspond to a Fifth Generation (“5G”) network, and/or may include elements of a 5G network. In some embodiments, environment 800 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 800 may represent or may include a 5G core (“5GC”). As shown, environment 800 may include UE 103, RAN 810 (which may include one or more Next Generation Node Bs (“gNBs”) 811), RAN 812 (which may include one or more evolved Node Bs (“eNBs”) 813), and various network functions such as AMF 101, Mobility Management Entity (“MME”) 816, Serving Gateway (“SGW”) 817, Session Management Function (“SMF”)/Packet Data Network (“PDN”) Gateway (“PGW”)-Control plane function (“PGW-C”) 820, Policy Control Function (“PCF”)/Policy Charging and Rules Function (“PCRF”) 825, Application Function (“AF”) 830, User Plane Function (“UPF”)/PGW-User plane function (“PGW-U”) 835, Unified Data Management (“UDM”)/Home Subscriber Server (“HSS”) 840, Authentication Server Function (“AUSF”) 845, and Network Exposure Function (“NEF”)/Service Capability Exposure Function (“SCEF”) 849. Environment 800 may also include one or more networks, such as Data Network (“DN”) 850. Environment 800 may include one or more additional devices or systems communicatively coupled to one or more networks (e.g., DN 850), such as one or more external devices 854.

The example shown in FIG. 8 illustrates one instance of each network component or function (e.g., one instance of SMF/PGW-C 820, PCF/PCRF 825, UPF/PGW-U 835, UDM/HSS 840, and/or AUSF 845). In practice, environment 800 may include multiple instances of such components or functions. For example, in some embodiments, environment 800 may include multiple “slices” of a core network, where each slice includes a discrete and/or logical set of network functions (e.g., one slice may include a first instance of AMF 101, SMF/PGW-C 820, PCF/PCRF 825, and/or UPF/PGW-U 835, while another slice may include a second instance of AMF 101, SMF/PGW-C 820, PCF/PCRF 825, and/or UPF/PGW-U 835). The different slices may provide differentiated levels of service, such as service in accordance with different Quality of Service (“QoS”) parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Additionally, one or more elements of environment 800 may be implemented in a virtualized and/or containerized manner. For example, one or more of the elements of environment 800 may be implemented by one or more Virtualized Network Functions (“VNFs”), Cloud-Native Network Functions (“CNFs”), etc. In such embodiments, environment 800 may include, may implement, and/or may be communicatively coupled to an orchestration platform that provisions hardware resources, installs containers or applications, performs load balancing, and/or otherwise manages the deployment of such elements of environment 800. In some embodiments, such orchestration and/or management of such elements of environment 800 may be performed by, or in conjunction with, the open-source Kubernetes® application programming interface (“API”) or some other suitable virtualization, containerization, and/or orchestration system.

Elements of environment 800 may interconnect with each other and/or other devices via wired connections, wireless connections, or a combination of wired and wireless connections. Examples of interfaces or communication pathways between the elements of environment 800, as shown in FIG. 8, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 8, such as Service-Based Interfaces (“SBIs”), including an Namf interface, an Nudm interface, an Npcf interface, an Nupf interface, an Nnef interface, an Nsmf interface, and/or one or more other SBIs.

UE 103 may include a computation and communication device, such as a wireless mobile communication device that is capable of communicating with RAN 810, RAN 812, and/or DN 850. UE 103 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 103 may send traffic to and/or receive traffic (e.g., user plane traffic) from DN 850 via RAN 810, RAN 812, and/or UPF/PGW-U 835.

RAN 810 may be, or may include, a 5G RAN that implements a 5G RAT and that includes one or more base stations (e.g., one or more gNBs 811), via which UE 103 may communicate with one or more other elements of environment 800. UE 103 may communicate with RAN 810 via an air interface (e.g., as provided by gNB 811). For instance, RAN 810 may receive traffic (e.g., user plane traffic such as voice call traffic, data traffic, messaging traffic, etc.) from UE 103 via the air interface, and may communicate the traffic to UPF/PGW-U 835 and/or one or more other devices or networks. Further, RAN 810 may receive signaling traffic, control plane traffic, etc. from UE 103 via the air interface, and may communicate such signaling traffic, control plane traffic, etc. to AMF 101 and/or one or more other devices or networks. Additionally, RAN 810 may receive traffic intended for UE 103 (e.g., from UPF/PGW-U 835, AMF 101, and/or one or more other devices or networks) and may communicate the traffic to UE 103 via the air interface. In some embodiments, base station 105 may be, may include, and/or may be implemented by one or more gNBs 811.

RAN 812 may be, or may include, an LTE RAN that implements an LTE RAT and that includes one or more base stations (e.g., one or more eNBs 813), via which UE 103 may communicate with one or more other elements of environment 800. UE 103 may communicate with RAN 812 via an air interface (e.g., as provided by eNB 813). For instance, RAN 812 may receive traffic (e.g., user plane traffic such as voice call traffic, data traffic, messaging traffic, signaling traffic, etc.) from UE 103 via the air interface, and may communicate the traffic to UPF/PGW-U 835 (e.g., via SGW 817) and/or one or more other devices or networks. Further, RAN 812 may receive signaling traffic, control plane traffic, etc. from UE 103 via the air interface, and may communicate such signaling traffic, control plane traffic, etc. to MME 816 and/or one or more other devices or networks. Additionally, RAN 812 may receive traffic intended for UE 103 (e.g., from UPF/PGW-U 835, MME 816, SGW 817, and/or one or more other devices or networks) and may communicate the traffic to UE 103 via the air interface. In some embodiments, base station 105 may be, may include, and/or may be implemented by one or more eNBs 813.

One or more RANs of environment 800 (e.g., RAN 810 and/or RAN 812) may include, may implement, and/or may otherwise be communicatively coupled to one or more edge computing devices, such as one or more Multi-Access/Mobile Edge Computing (“MEC”) devices (referred to sometimes herein simply as a “MECs”) 814. MECs 814 may be co-located with wireless network infrastructure equipment of RANs 810 and/or 812 (e.g., one or more gNBs 811 and/or one or more eNBs 813, respectively). Additionally, or alternatively, MECs 814 may otherwise be associated with geographical regions (e.g., coverage areas) of wireless network infrastructure equipment of RANs 810 and/or 812. In some embodiments, one or more MECs 814 may be implemented by the same set of hardware resources, the same set of devices, etc. that implement wireless network infrastructure equipment of RANs 810 and/or 812. In some embodiments, one or more MECs 814 may be implemented by different hardware resources, a different set of devices, etc. from hardware resources or devices that implement wireless network infrastructure equipment of RANs 810 and/or 812. In some embodiments, MECs 814 may be communicatively coupled to wireless network infrastructure equipment of RANs 810 and/or 812 (e.g., via a high-speed and/or low-latency link such as a physical wired interface, a high-speed and/or low-latency wireless interface, or some other suitable communication pathway).

MECs 814 may include hardware resources (e.g., configurable or provisionable hardware resources) that may be configured to provide services and/or otherwise process traffic to and/or from UE 103, via RAN 810 and/or 812. For example, RAN 810 and/or 812 may route some traffic from UE 103 (e.g., traffic associated with one or more particular services, applications, application types, etc.) to a respective MEC 814 instead of to core network elements of 800 (e.g., UPF/PGW-U 835). MEC 814 may accordingly provide services to UE 103 by processing such traffic, performing one or more computations based on the received traffic, and providing traffic to UE 103 via RAN 810 and/or 812. MEC 814 may include, and/or may implement, some or all of the functionality described above with respect to UPF/PGW-U 835, AF 830, one or more application servers, and/or one or more other devices, systems, VNFs, CNFs, etc. In this manner, ultra-low latency services may be provided to UE 103, as traffic does not need to traverse links (e.g., backhaul links) between RAN 810 and/or 812 and the core network.

AMF 101 may include one or more devices, systems, VNFs, CNFs, etc., that perform operations to register UE 103 with the 5G network, to establish bearer channels associated with a session with UE 103, to hand off UE 103 from the 5G network to another network, to hand off UE 103 from the other network to the 5G network, manage mobility of UE 103 between RANs 810 and/or gNBs 811, and/or to perform other operations. In some embodiments, the 5G network may include multiple AMFs 101, which communicate with each other via the N14 interface (denoted in FIG. 8 by the line marked “N14” originating and terminating at AMF 101).

MME 816 may include one or more devices, systems, VNFs, CNFs, etc., that perform operations to register UE 103 with the EPC, to establish bearer channels associated with a session with UE 103, to hand off UE 103 from the EPC to another network, to hand off UE 103 from another network to the EPC, manage mobility of UE 103 between RANs 812 and/or eNBs 813, and/or to perform other operations.

SGW 817 may include one or more devices, systems, VNFs, CNFs, etc., that aggregate traffic received from one or more eNBs 813 and send the aggregated traffic to an external network or device via UPF/PGW-U 835. Additionally, SGW 817 may aggregate traffic received from one or more UPF/PGW-Us 835 and may send the aggregated traffic to one or more eNBs 813. SGW 817 may operate as an anchor for the user plane during inter-eNB handovers and as an anchor for mobility between different telecommunication networks or RANs (e.g., RANs 810 and 812).

SMF/PGW-C 820 may include one or more devices, systems, VNFs, CNFs, etc., that gather, process, store, and/or provide information in a manner described herein. SMF/PGW-C 820 may, for example, facilitate the establishment of communication sessions on behalf of UE 103. In some embodiments, the establishment of communications sessions may be performed in accordance with one or more policies provided by PCF/PCRF 825.

PCF/PCRF 825 may include one or more devices, systems, VNFs, CNFs, etc., that aggregate information to and from the 5G network and/or other sources. PCF/PCRF 825 may receive information regarding policies and/or subscriptions from one or more sources, such as subscriber databases and/or from one or more users (such as, for example, an administrator associated with PCF/PCRF 825).

AF 830 may include one or more devices, systems, VNFs, CNFs, etc., that receive, store, and/or provide information that may be used in determining parameters (e.g., quality of service parameters, charging parameters, or the like) for certain applications.

UPF/PGW-U 835 may include one or more devices, systems, VNFs, CNFs, etc., that receive, store, and/or provide data (e.g., user plane data). For example, UPF/PGW-U 835 may receive user plane data (e.g., voice call traffic, data traffic, etc.), destined for UE 103, from DN 850, and may forward the user plane data toward UE 103 (e.g., via RAN 810, SMF/PGW-C 820, and/or one or more other devices). In some embodiments, multiple instances of UPF/PGW-U 835 may be deployed (e.g., in different geographical locations), and the delivery of content to UE 103 may be coordinated via the N9 interface (e.g., as denoted in FIG. 8 by the line marked “N9” originating and terminating at UPF/PGW-U 835). Similarly, UPF/PGW-U 835 may receive traffic from UE 103 (e.g., via RAN 810, RAN 812, SMF/PGW-C 820, and/or one or more other devices), and may forward the traffic toward DN 850. In some embodiments, UPF/PGW-U 835 may communicate (e.g., via the N4 interface) with SMF/PGW-C 820, regarding user plane data processed by UPF/PGW-U 835.

UDM/HSS 840 and AUSF 845 may include one or more devices, systems, VNFs, CNFs, etc., that manage, update, and/or store, in one or more memory devices associated with AUSF 845 and/or UDM/HSS 840, profile information associated with a subscriber. In some embodiments, UDM/HSS 840 may include, may implement, may be communicatively coupled to, and/or may otherwise be associated with some other type of repository or database, such as a Unified Data Repository (“UDR”). AUSF 845 and/or UDM/HSS 840 may perform authentication, authorization, and/or accounting operations associated with one or more UEs 103 and/or one or more communication sessions associated with one or more UEs 103.

DN 850 may include one or more wired and/or wireless networks. For example, DN 850 may include an Internet Protocol (“IP”)-based PDN, a wide area network (“WAN”) such as the Internet, a private enterprise network, and/or one or more other networks. UE 103 may communicate, through DN 850, with data servers, other UEs 103, and/or to other servers or applications that are coupled to DN 850. DN 850 may be connected to one or more other networks, such as a public switched telephone network (“PSTN”), a public land mobile network (“PLMN”), and/or another network. DN 850 may be connected to one or more devices, such as content providers, applications, web servers, and/or other devices, with which UE 103 may communicate.

External devices 854 may include one or more devices or systems that communicate with UE 103 via DN 850 and one or more elements of 800 (e.g., via UPF/PGW-U 835). External devices 854 may include, for example, one or more application servers, content provider systems, web servers, or the like. External devices 854 may, for example, implement “server-side” applications that communicate with “client-side” applications executed by UE 103. External devices 854 may provide services to UE 103 such as gaming services, videoconferencing services, messaging services, email services, web services, and/or other types of services. Operations described above with respect to a given external device 854 (e.g., in accordance with some embodiments) may be performed by a single device, by a cloud computing system, by one or more devices that implement a virtualized or containerized environment, a collection of devices, etc.

In some embodiments, external devices 854 may communicate with one or more elements of environment 800 (e.g., core network elements) via NEF/SCEF 849. NEF/SCEF 849 include one or more devices, systems, VNFs, CNFs, etc. that provide access to information, APIs, and/or other operations or mechanisms of one or more core network elements to devices or systems that are external to the core network (e.g., to external device 854 via DN 850). NEF/SCEF 849 may maintain authorization and/or authentication information associated with such external devices or systems, such that NEF/SCEF 849 is able to provide information, that is authorized to be provided, to the external devices or systems. For example, a given external device 854 may request particular information associated with one or more core network elements. NEF/SCEF 849 may authenticate the request and/or otherwise verify that external device 854 is authorized to receive the information, and may request, obtain, or otherwise receive the information from the one or more core network elements. In some embodiments, NEF/SCEF 849 may include, may implement, may be implemented by, may be communicatively coupled to, and/or may otherwise be associated with a Security Edge Protection Proxy (“SEPP”), which may perform some or all of the functions discussed above. External device 854 may, in some situations, subscribe to particular types of requested information provided by the one or more core network elements, and the one or more core network elements may provide (e.g., “push”) the requested information to NEF/SCEF 849 (e.g., in a periodic or otherwise ongoing basis).

In some embodiments, external devices 854 may communicate with one or more elements of RAN 810 and/or 812 via an API or other suitable interface. For example, a given external device 854 may provide instructions, requests, etc. to RAN 810 and/or 812 to provide one or more services via one or more respective MECs 814. In some embodiments, such instructions, requests, etc. may include QoS parameters, Service Level Agreements (“SLAs”), etc. (e.g., maximum latency thresholds, minimum throughput thresholds, etc.) associated with the services.

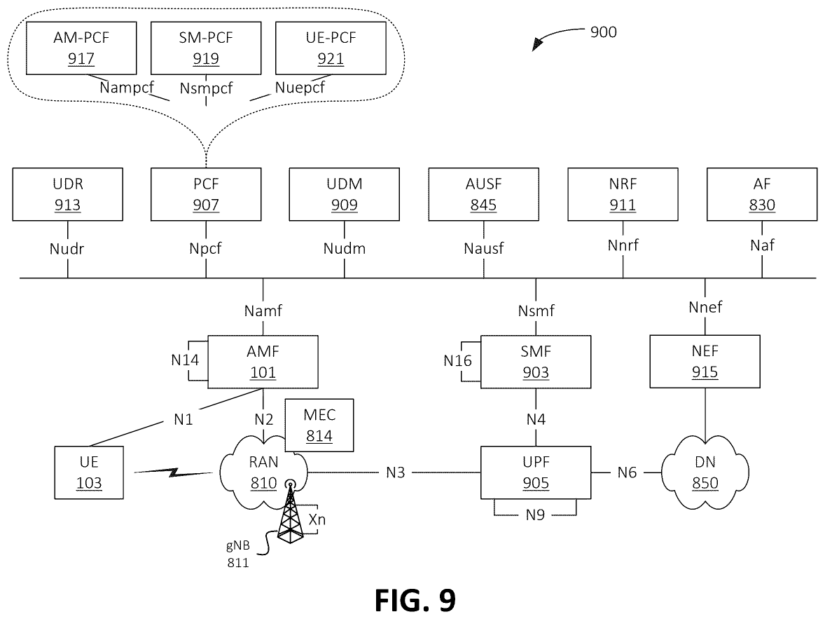

FIG. 9 illustrates another example environment 900, in which one or more embodiments may be implemented. In some embodiments, environment 900 may correspond to a 5G network, and/or may include elements of a 5G network. In some embodiments, environment 900 may correspond to a 5G SA architecture. In some embodiments, environment 900 may include a 5GC, in which 5GC network elements perform one or more operations described herein.

As shown, environment 900 may include UE 103, RAN 810 (which may include one or more gNBs 811 or other types of wireless network infrastructure) and various network functions, which may be implemented as VNFs, CNFs, etc. Such network functions may include AMF 101, SMF 903, UPF 905, PCF 907, UDM 909, AUSF 845, Network Repository Function (“NRF”) 911, AF 830, UDR 913, and NEF 915. Environment 900 may also include or may be communicatively coupled to one or more networks, such as DN 850.

The example shown in FIG. 9 illustrates one instance of each network component or function (e.g., one instance of SMF 903, UPF 905, PCF 907, UDM 909, AUSF 845, etc.). In practice, environment 900 may include multiple instances of such components or functions. For example, in some embodiments, environment 900 may include multiple “slices” of a core network, where each slice includes a discrete and/or logical set of network functions (e.g., one slice may include a first instance of SMF 903, PCF 907, UPF 905, etc., while another slice may include a second instance of SMF 903, PCF 907, UPF 905, etc.). Additionally, or alternatively, one or more of the network functions of environment 900 may implement multiple network slices. The different slices may provide differentiated levels of service, such as service in accordance with different QoS parameters.

The quantity of devices and/or networks, illustrated in FIG. 9, is provided for explanatory purposes only. In practice, environment 900 may include additional devices and/or networks, fewer devices and/or networks, different devices and/or networks, or differently arranged devices and/or networks than illustrated in FIG. 9. For example, while not shown, environment 900 may include devices that facilitate or enable communication between various components shown in environment 900, such as routers, modems, gateways, switches, hubs, etc. In some implementations, one or more devices of environment 900 may be physically integrated in, and/or may be physically attached to, one or more other devices of environment 900. Alternatively, or additionally, one or more of the devices of environment 900 may perform one or more network functions described as being performed by another one or more of the devices of environment 900.

Elements of environment 900 may interconnect with each other and/or other devices via wired connections, wireless connections, or a combination of wired and wireless connections. Examples of interfaces or communication pathways between the elements of environment 900, as shown in FIG. 9, may include interfaces shown in FIG. 9 and/or one or more interfaces not explicitly shown in FIG. 9. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 900 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 101), an Nudm interface (e.g., indicating communications to be routed to UDM 909), an Npcf interface, an Nupf interface, an Nnef interface, an Nsmf interface, an Nnrf interface, an Nudr interface, an Naf interface, and/or one or more other SBIs.

UPF 905 may include one or more devices, systems, VNFs, CNFs, etc., that receive, route, process, and/or forward traffic (e.g., user plane traffic). As discussed above, UPF 905 may communicate with UE 103 via one or more communication sessions, such as PDU sessions. Such PDU sessions may be associated with a particular network slice or other suitable QoS parameters, as noted above. UPF 905 may receive downlink user plane traffic (e.g., voice call traffic, data traffic, etc. destined for UE 103) from DN 850, and may forward the downlink user plane traffic toward UE 103 (e.g., via RAN 810). In some embodiments, multiple UPFs 905 may be deployed (e.g., in different geographical locations), and the delivery of content to UE 103 may be coordinated via the N9 interface. Similarly, UPF 905 may receive uplink traffic from UE 103 (e.g., via RAN 810), and may forward the traffic toward DN 850. In some embodiments, UPF 905 may implement, may be implemented by, may be communicatively coupled to, and/or may otherwise be associated with UPF/PGW-U 835. In some embodiments, UPF 905 may communicate (e.g., via the N4 interface) with SMF 903, regarding user plane data processed by UPF 905 (e.g., to provide analytics or reporting information, to receive policy and/or authorization information, etc.).

PCF 907 may include one or more devices, systems, VNFs, CNFs, etc., that aggregate, derive, generate, etc. policy information associated with the 5GC and/or UEs 103 that communicate via the 5GC and/or RAN 810. PCF 907 may receive information regarding policies and/or subscriptions from one or more sources, such as subscriber databases (e.g., UDM 909, UDR 913, etc.), and/or from one or more users such as, for example, an administrator associated with PCF 907. In some embodiments, the functionality of PCF 907 may be split into multiple network functions or subsystems, such as access and mobility PCF (“AM-PCF”) 917, session management PCF (“SM-PCF”) 919, UE PCF (“UE-PCF”) 921, and so on. Such different “split” PCFs may be associated with respective SBIs (e.g., AM-PCF 917 may be associated with an Nampcf SBI, SM-PCF 919 may be associated with an Nsmpcf SBI, UE-PCF 921 may be associated with an Nuepcf SBI, and so on) via which other network functions may communicate with the split PCFs. The split PCFs may maintain information regarding policies associated with different devices, systems, and/or network functions.

NRF 911 may include one or more devices, systems, VNFs, CNFs, etc. that maintain routing and/or network topology information associated with the 5GC. For example, NRF 911 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 913 may include one or more devices, systems, VNFs, CNFs, etc. that provide user and/or subscriber information, based on which PCF 907 and/or other elements of environment 900 may determine access policies, QoS policies, charging policies, or the like. In some embodiments, UDR 913 may receive such information from UDM 909 and/or one or more other sources.

NEF 915 include one or more devices, systems, VNFs, CNFs, etc. that provide access to information, APIs, and/or other operations or mechanisms of the 5GC to devices or systems that are external to the 5GC. NEF 915 may maintain authorization and/or authentication information associated with such external devices or systems, such that NEF 915 is able to provide information, that is authorized to be provided, to the external devices or systems. Such information may be received from other network functions of the 5GC (e.g., as authorized by an administrator or other suitable entity associated with the 5GC), such as SMF 903, UPF 905, a charging function (“CHF”) of the 5GC, and/or other suitable network function. NEF 915 may communicate with external devices or systems (e.g., external devices 854) via DN 850 and/or other suitable communication pathways.

While environment 900 is described in the context of a 5GC, as noted above, environment 900 may, in some embodiments, include or implement one or more other types of core networks. For example, in some embodiments, environment 900 may be or may include a converged packet core, in which one or more elements may perform some or all of the functionality of one or more 5GC network functions and/or one or more EPC network functions. For example, in some embodiments, AMF 101 may include, may implement, may be implemented by, and/or may otherwise be associated with MME 816; SMF 903 may include, may implement, may be implemented by, and/or may otherwise be associated with SGW 817; PCF 907 may include, may implement, may be implemented by, and/or may otherwise be associated with a PCRF (e.g., PCF/PCRF 825); NEF 915 may include, may implement, may be implemented by, and/or may otherwise be associated with a SCEF (e.g., NEF/SCEF 849); and so on.

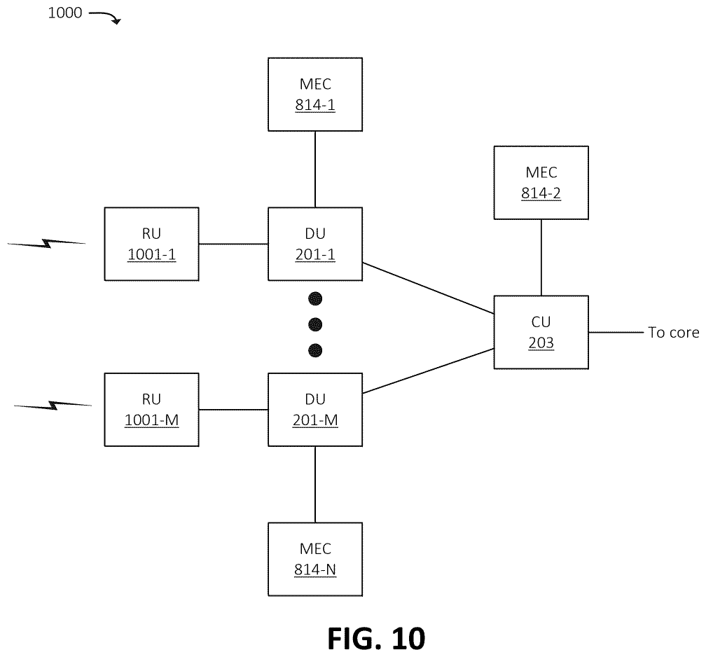

FIG. 10 illustrates an example RAN environment 1000, which may be included in and/or implemented by one or more RANs (e.g., RAN 810 or some other RAN). In some embodiments, a particular RAN 810 may include one RAN environment 1000. In some embodiments, a particular RAN 810 may include multiple RAN environments 1000. In some embodiments, RAN environment 1000 may correspond to a particular gNB 811 of RAN 810. In some embodiments, RAN environment 1000 may correspond to multiple gNBs 811. In some embodiments, RAN environment 1000 may correspond to one or more other types of base stations of one or more other types of RANs. As shown, RAN environment 1000 may include CU 203, one or more DUs 201-1 through 201-M (referred to individually as “DU 201,” or collectively as “DUs 201”), and one or more Radio Units (“RUs”) 1001-1 through 1001-M (referred to individually as “RU 1001,” or collectively as “RUs 1001”). While FIG. 10 is presented in the context of CU 203 and DUs 201, similar concepts are applicable to CU 303 and DUs 301.

CU 203 may communicate with a core of a wireless network (e.g., may communicate with one or more of the devices or systems described above with respect to FIG. 9, such as AMF 101 and/or UPF 905) and/or some other device or system such as MEC 814. In the uplink direction (e.g., for traffic from UEs 103 to a core network), CU 203 may aggregate traffic from DUs 201, and forward the aggregated traffic to the core network. In some embodiments, as noted above, CU 203 may receive traffic according to a given protocol (e.g., RLC traffic) from DUs 201, and may perform higher-layer processing (e.g., may aggregate/process RLC packets and generate PDCP packets based on the RLC packets) on the traffic received from DUs 201.

CU 203 may receive downlink traffic (e.g., traffic from the core network, traffic from a given MEC 814, etc.) for a particular UE 103, and may determine which DU(s) 201 should receive the downlink traffic. DU 201 may include one or more devices that transmit traffic between a core network (e.g., via CU 203) and UE 103 (e.g., via a respective RU 1001). DU 201 may, for example, receive traffic from RU 1001 at a first layer (e.g., physical (“PHY”) layer traffic, or lower PHY layer traffic), and may process/aggregate the traffic to a second layer (e.g., upper PHY and/or RLC). DU 201 may receive traffic from CU 203 at the second layer, may process the traffic to the first layer, and provide the processed traffic to a respective RU 1001 for transmission to UE 103.

RU 1001 may include hardware circuitry (e.g., one or more RF transceivers, antennas, radios, and/or other suitable hardware) to communicate wirelessly (e.g., via an RF interface) with one or more UEs 103, one or more other DUs 201 (e.g., via RUs 1001 associated with DUs 201), and/or any other suitable type of device. In the uplink direction, RU 1001 may receive traffic from UE 103 and/or another DU 201 via the RF interface and may provide the traffic to DU 201. In the downlink direction, RU 1001 may receive traffic from DU 201, and may provide the traffic to UE 103 and/or another DU 201.

One or more elements of RAN environment 1000 may, in some embodiments, be communicatively coupled to one or more MECs 814. For example, DU 201-1 may be communicatively coupled to MEC 814-1, DU 201-M may be communicatively coupled to MEC 814-N, CU 203 may be communicatively coupled to MEC 814-2, and so on. MECs 814 may include hardware resources (e.g., configurable or provisionable hardware resources) that may be configured to provide services and/or otherwise process traffic to and/or from UE 103, via a respective RU 1001.

For example, DU 201-1 may route some traffic, from UE 103, to MEC 814-1 instead of to a core network via CU 203. MEC 814-1 may process the traffic, perform one or more computations based on the received traffic, and may provide traffic to UE 103 via RU 1001-1. As discussed above, MEC 814 may include, and/or may implement, some or all of the functionality described above with respect to UPF 905, AF 830, and/or one or more other devices, systems, VNFs, CNFs, etc. In this manner, ultra-low latency services may be provided to UE 103, as traffic does not need to traverse DU 201, CU 203, links between DU 201 and CU 203, and an intervening backhaul network between RAN environment 1000 and the core network.

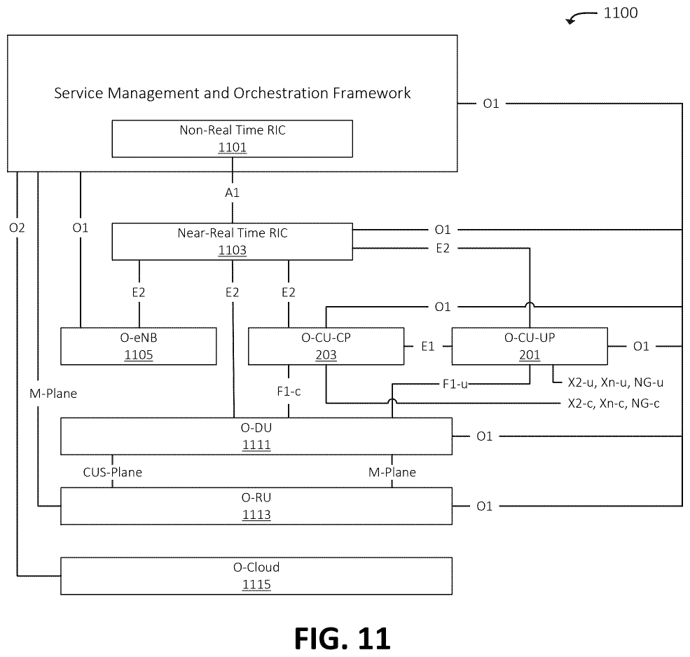

FIG. 11 illustrates an example O-RAN environment 1100, which may correspond to RAN 810, RAN 812, and/or RAN environment 1000. For example, RAN 810, RAN 812, and/or RAN environment 1000 may include one or more instances of O-RAN environment 1100, and/or one or more instances of O-RAN environment 1100 may implement RAN 810, RAN 812, RAN environment 1000, and/or some portion thereof. As shown, O-RAN environment 1100 may include Non-Real Time Radio Intelligent Controller (“RIC”) 1101, Near-Real Time RIC 1103, O-eNB 1105, O-CU-Control Plane (“O-CU-CP”) 1203, O-CU-User Plane (“O-CU-UP”) 1201, O-DU 1111, O-RU 1113, and O-Cloud 1115. In some embodiments, O-RAN environment 1100 may include additional, fewer, different, and/or differently arranged components or interfaces.

In some embodiments, some or all of the elements of O-RAN environment 1100 may be implemented by one or more configurable or provisionable resources, such as virtual machines, cloud computing systems, physical servers, and/or other types of configurable or provisionable resources. In some embodiments, some or all of O-RAN environment 1100 may be implemented by, and/or communicatively coupled to, one or more MECs 814.

Non-Real Time RIC 1101 and Near-Real Time RIC 1103 may receive performance information (and/or other types of information) from one or more sources, and may configure other elements of O-RAN environment 1100 based on such performance or other information. For example, Near-Real Time RIC 1103 may receive performance information, via one or more E2 interfaces, from O-eNB 1105, O-CU-CP 1203, and/or O-CU-UP 1201, and may modify parameters associated with O-eNB 1105, O-CU-CP 1203, and/or O-CU-UP 1201 based on such performance information. Similarly, Non-Real Time RIC 1101 may receive performance information associated with O-eNB 1105, O-CU-CP 1203, O-CU-UP 1201, and/or one or more other elements of O-RAN environment 1100 and may utilize machine learning and/or other higher level computing or processing to determine modifications to the configuration of O-eNB 1105, O-CU-CP 1203, O-CU-UP 1201, and/or other elements of O-RAN environment 1100. In some embodiments, Non-Real Time RIC 1101 may generate machine learning models based on performance information associated with O-RAN environment 1100 or other sources, and may provide such models to Near-Real Time RIC 1103 for implementation.

O-eNB 1105 may perform functions similar to those described above with respect to gNB 811 and/or eNB 813. For example, O-eNB 1105 may facilitate wireless communications between UE 103 and a core network. O-CU-CP 1203 may perform control plane signaling to coordinate the aggregation and/or distribution of traffic via one or more DUs 201, which may include and/or be implemented by one or more O-DUs 1111, and O-CU-UP 1201 may perform the aggregation and/or distribution of traffic via such DUs 201 (e.g., O-DUs 1111). O-DU 1111 may be communicatively coupled to one or more RUs 1001, which may include and/or may be implemented by one or more O-RUs 1113. In some embodiments, O-Cloud 1115 may include or be implemented by one or more MECs 814, which may provide services, and may be communicatively coupled, to O-CU-CP 1203, O-CU-UP 1201, O-DU 1111, and/or O-RU 1113 (e.g., via an O1 and/or O2 interface).

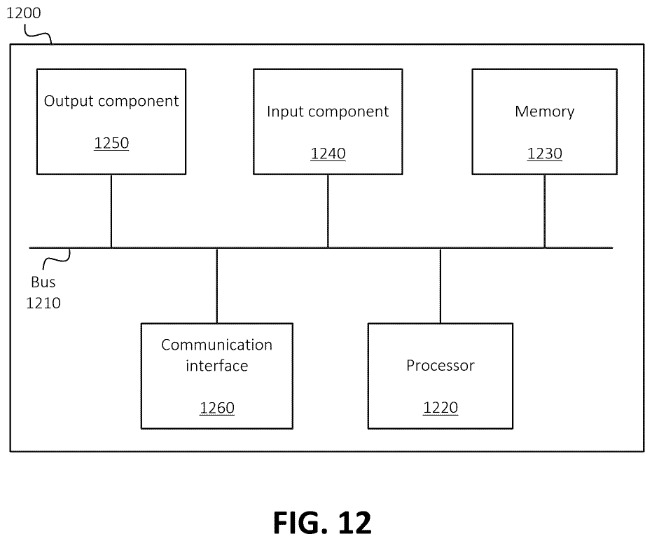

FIG. 12 illustrates example components of device 1200. One or more of the devices described above may include one or more devices 1200. Device 1200 may include bus 1210, processor 1220, memory 1230, input component 1240, output component 1250, and communication interface 1260. In another implementation, device 1200 may include additional, fewer, different, or differently arranged components.

Bus 1210 may include one or more communication paths that permit communication among the components of device 1200. Processor 1220 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 1220 may be or may include one or more hardware processors. Memory 1230 may include any type of dynamic storage device that may store information and instructions for execution by processor 1220, and/or any type of non-volatile storage device that may store information for use by processor 1220.

Input component 1240 may include a mechanism that permits an operator to input information to device 1200 and/or other receives or detects input from a source external to input component 1240, such as a touchpad, a touchscreen, a keyboard, a keypad, a button, a switch, a microphone or other audio input component, etc. In some embodiments, input component 1240 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1250 may include a mechanism that outputs information to the operator, such as a display, a speaker, one or more light emitting diodes (“LEDs”), etc.

Communication interface 1260 may include any transceiver-like mechanism that enables device 1200 to communicate with other devices and/or systems (e.g., via RAN 810, RAN 812, DN 850, etc.). For example, communication interface 1260 may include an Ethernet interface, an optical interface, a coaxial interface, or the like. Communication interface 1260 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1200 may include more than one communication interface 1260. For instance, device 1200 may include an optical interface, a wireless interface, an Ethernet interface, and/or one or more other interfaces.

Device 1200 may perform certain operations relating to one or more processes described above. Device 1200 may perform these operations in response to processor 1220 executing instructions, such as software instructions, processor-executable instructions, etc. stored in a computer-readable medium, such as memory 1230. A computer-readable medium may be defined as a non-transitory memory device. A memory device may include space within a single physical memory device or spread across multiple physical memory devices. The instructions may be read into memory 1230 from another computer-readable medium or from another device. The instructions stored in memory 1230 may be processor-executable instructions that cause processor 1220 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-4, 5A, 5B, and 6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Additionally, examples are provided above in the context of keys (e.g., Key_A, Key_B, etc.). In some embodiments, similar concepts may be applied to key pairs or portions thereof. For example, examples referring to Key_A may include a first set of keys (e.g., an asymmetric key pair, a particular key of a key pair, a key or value derived from one or more keys of a key pair, etc.). Similarly, examples referring to Key_B may include a second set of keys.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A first device, comprising:
one or more processors configured to:
generate or receive a first key;
utilize the first key to secure a first set of communications between the first device and a User Equipment (“UE”);
identify that the first key has been provided to a second device;
based on identifying that the first key has been provided to a second device:
generate a second key based on the first key, and
instruct the UE to generate the second key based on the first key; and
utilize the second key to secure a second set of communications between the first device and the UE.

2. The first device of claim 1, wherein generating the first key includes:
receiving a third key, and
generating the first key based on the third key.

3. The first device of claim 2, wherein the third key is received by the UE, wherein the UE generates the first key based on the third key.

4. The first device of claim 1, wherein the one or more processors are further configured to identify a handover event associated with the UE and the second device, wherein the first key is provided to the second device based on identifying the handover event associated with the UE and the second device.

5. The first device of claim 1, wherein the first device is associated with a first base station of a radio access network (“RAN”) of a wireless network, and wherein the second device is associated with a second base station of the RAN of the wireless network.

6. The first device of claim 5, wherein the first device includes a first Central Unit (“CU”), and wherein the second device includes a second CU.

7. The first device of claim 1, wherein the first set of communications includes a set of Radio Resource Control (“RRC”) communications, and wherein the second set of communications includes a set of Media Access Control (“MAC”) layer communications.

8. A system, comprising:
a first device configured to generate or receive a first key; and
a UE configured to generate or receive the first key,
wherein the first device and the UE are further configured to utilize the first key to secure a first set of communications between the first device and the UE,
wherein the first device is further configured to:
identify that the first key has been provided to a second device; and
based on identifying that the first key has been provided to a second device:
generate a second key based on the first key, and
output an instruction to the UE to generate the second key based on the first key,
wherein the UE is further configured to generate the second key based on the instruction, and
wherein the first device and the UE are further configured to utilize the second key to secure a second set of communications between the first device and the UE.

9. The system of claim 8,
wherein the first device is further configured to:
receive a third key, and
generate the first key based on the third key; and
wherein the UE is further configured to:
receive the third key, and
generate the first key based on the third key.

10. The system of claim 8, wherein the first device is further configured to identify a handover event associated with the UE and the second device, wherein the first key is provided to the second device based on identifying the handover event associated with the UE and the second device.

11. The system of claim 8, wherein the first device is associated with a first base station of a radio access network (“RAN”) of a wireless network, and wherein the second device is associated with a second base station of the RAN of the wireless network.

12. The system of claim 11, wherein the first device includes a first Central Unit (“CU”), and wherein the second device includes a second CU.

13. The system of claim 8, wherein the first set of communications includes a set of Radio Resource Control (“RRC”) communications, and wherein the second set of communications includes a set of Media Access Control (“MAC”) layer communications.

14. A method, comprising:
generating or receiving, by a first device, a first key;
utilizing the first key to secure a first set of communications between the first device and a User Equipment (“UE”);
identifying that the first key has been provided to a second device;
based on identifying that the first key has been provided to a second device:
generating a second key based on the first key, and
instructing the UE to generate the second key based on the first key; and
utilizing the second key to secure a second set of communications between the first device and the UE.

15. The method of claim 14, wherein generating the first key includes:
receiving a third key, and
generating the first key based on the third key.

16. The method of claim 15, wherein the third key is received by the UE, wherein the UE generates the first key based on the third key.

17. The method of claim 14, further comprising identifying a handover event associated with the UE and the second device, wherein the first key is provided to the second device based on identifying the handover event associated with the UE and the second device.

18. The method of claim 14, wherein the first device is associated with a first base station of a radio access network (“RAN”) of a wireless network, and wherein the second device is associated with a second base station of the RAN of the wireless network.

19. The method of claim 18, wherein the first device includes a first Central Unit (“CU”), and wherein the second device includes a second CU.

20. The method of claim 14, wherein the first set of communications includes a set of Radio Resource Control (“RRC”) communications, and wherein the second set of communications includes a set of Media Access Control (“MAC”) layer communications.
